(19) United States
(12) Patent Application Publication
(10) Pub. No.: US 2024/0361122 A1
(43) Pub. Date: Oct. 31, 2024

(54) SURFACE IDENTIFICATION SENSOR USING REFLECTED LIGHT AND MACHINE LEARNING

(71) Applicant: Useful Sensors Inc., Mountain View, CA (US)

(72) Inventors: James Muyao Wang, Rosamond, CA (US); Peter Charles Warden, San Francisco, CA (US)

(73) Assignee: Useful Sensors Inc., Mountain View, CA (US)

(21) Appl. No.: 18/646,967

(22) Filed: Apr. 26, 2024

Related U.S. Application Data
(60) Provisional application No. 63/471,997, filed on Jun. 9, 2023.
(60) Provisional application No. 63/462,545, filed on Apr. 28, 2023.
(60) Provisional application No. 63/637,418, filed on Apr. 23, 2024.

(51) Int. Cl. G01B 11/30

(52) U.S. Cl. CPC G01B 11/303

(57) ABSTRACT

Techniques for sensing surfaces based on reflected light and machine learning are disclosed. A housing is used, which includes a first light source and a first photosensor. The first light source is mounted to project light downward and the first photosensor is mounted to capture light reflected upward. Data from the first photosensor is used with a machine learning model. The housing is moved a minimum distance along the surface. The distance allows for detection, by the first photosensor, of reflected light from the first light source off the surface. Light is sent from the first light source. Reflected light from the first light source is captured by the first photosensor. An output of the first photosensor is interpreted by the machine learning model. The interpreting recognizes a surface texture. A composition of the surface is identified based on the texture.

### RELATED APPLICATIONS

This application claims the benefit of U.S. provisional patent applications “Surface Identification Sensor Using Reflected Light And Machine Learning” Ser. No. 63/462,545, filed Apr. 28, 2023, “Low-Resolution Embedded Face Identification Sensor With Machine Learning” Ser. No. 63/471,997, filed Jun. 9, 2023, and “Low Power Passive Infrared Human Sensor With Machine Learning” Ser. No. 63/637,418, filed Apr. 23, 2024.

Each of the foregoing applications is hereby incorporated by reference in its entirety.

### FIELD OF ART

This application relates generally to sensing surfaces and more particularly to a surface identification sensor using reflected light and machine learning.

### BACKGROUND

Humans use a wide variety of materials in their daily lives. The materials can include natural materials among many others. Other commonly used materials include metals in their elemental or alloyed forms. Metal alloys such as steel, an alloy comprised of iron and other elements, are useful because when other elements are added to iron, various desirable proportions are achieved. Further materials include glass and ceramic, which have applications that range from windows to tableware. Manufactured materials such as synthetic and “bio-based” plastics are also useful. The synthetic plastics are generally made from derived petroleum which is nonrenewable. The bio-based plastics are derived from renewable sources such as vegetable fats and oils, starch, and carbohydrates. Many of these materials can be reused and recycled, which is particularly fortuitous since the petroleum-based plastics have a very long lifespan and are not considered environmentally friendly. Other materials biodegrade over time, thereby reducing plastic amounts in landfills or at-large in the environment.

Depending on the type of material, various techniques can be used to test the material. Some of the testing techniques are destructive while others are not. Also, some tests require specialized equipment to perform the tests. When the material is a metal, common testing techniques often include an appearance, spark, Rockwell hardness, and Brinell hardness tests. The appearance test can be conducted by a visual inspection of the metal. The appearance test classifies metal and does not require equipment, but is not necessarily conclusive. The spark test is again based on appearance of a spark or a lack of a spark when the material is applied to a grinding wheel. The spark test classifies metal, requires equipment, and requires a trained individual. The Rockwell hardness test requires no special equipment and tests metal hardness by a depth of an impression. The metal surface must be prepared prior to the test. The Brinell hardness test needs equipment to test the metal hardness, measures the area of the impression, and is used on a rough surface. Similar and other tests can be applied to materials such as fabrics, plastics, and other materials.

The many materials that are used, whether elemental, alloyed, manufactured, or natural, find their way into a dizzying array of products and applications. Fabrics of various types are used for clothing that ranges from the modest to the daring, and fashionable to protective. Wood, metal, stone, and ceramics are commonly used as building materials, as are cob and straw. Fabric is also used for shelter such as emergency tents and yurts. Materials are widely used for vehicles and transportation systems. The vehicles can range from wooden carts to aircraft, where each vehicle type uses one or more materials. Transportation systems, such as road networks and public transportation, can use a variety of materials. Some of the materials used for road networks include macadam, bitumen, and concrete. Public transportation is based on vehicles that are constructed from wood, metal, and plastic. Whatever the purpose or application, materials play a key role in support of daily living.

### SUMMARY

Visual inspection of materials can be greatly enhanced by using light and sensors to sense surface characteristics such as texture and composition of the materials. The sensing can be based on illuminating the surface using a light source. Light that reflects off the surface, whether the reflecting is upward, back, or across the surface, can be captured using at least one photosensor, forming one or more analog data channels. The sensing is enabled by moving a housing that includes the light source and the photosensor across the surface. The reflected light captured by the photosensor(s) generates a signal from the one or more analog channels that can be analyzed to determine the surface characteristics such as surface texture and surface composition. The analysis is performed by a microcontroller that is coupled to the light source and the photosensor. The microcontroller controls the light source and collects data from the photosensor. The collected data is analyzed using a machine learning model that is executed on the microcontroller. The machine learning model can be used to configure a convolutional neural network on the microcontroller. The machine learning model uses the photosensor data to interpret a texture of the surface. A composition of the surface is identified based on the texture.

Techniques for sensing surfaces based on reflected light and machine learning are disclosed. A housing is used, which includes a first light source and a first photosensor. The first light source is mounted to project light downward and the first photosensor is mounted to capture light reflected upward. Data from the first photosensor is used with a machine learning model. The housing is moved a minimum distance along the surface. The distance allows for detection, by the first photosensor, of reflected light from the first light source off the surface. Light is sent from the first light source. Reflected light from the first light source is captured by the first photosensor. An output of the first photosensor is interpreted by the machine learning model. The interpreting recognizes a surface texture. A composition of the surface is identified based on the texture.

A processor-implemented method for sensing surfaces is disclosed comprising: using a housing, wherein the housing includes a first light source and a first photosensor for the first light source, wherein the first light source is mounted to project light downward and the first photosensor is mounted to capture light reflected upward from a surface, and wherein data from the first photosensor is used with a machine learning model; moving, within a minimum distance, the housing along the surface, wherein the minimum distance allows for detection, by the first photosensor, of reflected light from the first light source off the surface; sending light from the first light source; capturing, by the first photosensor, reflected light from the first light source; interpreting, by the machine learning model, an output of the first photosensor, wherein the interpreting recognizes a texture of the surface; and identifying a composition of the surface, based on the texture. In embodiments, the housing includes a second photosensor for the first light source and wherein the second photosensor for the first light source captures light reflected upward from a surface and wherein the interpreting is based on data from the second photosensor. And in embodiments, the interpreting is based on data from the first photosensor or the second photosensor, even when one of the first photosensor or the second photosensor is occluded from receiving reflected light from the first light source.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a surface identification sensor using reflected light and machine learning.

FIG. 2 is a flow diagram for detecting light.

FIG. 3 shows a first example sensor housing configuration.

FIG. 4 illustrates a second example sensor housing configuration.

FIG. 5 shows an example surface identification sensor.

FIG. 6 illustrates carpet sensing data from a surface identification sensor.

FIG. 7 shows flooring sensing data from a surface identification sensor.

FIG. 8 is a system diagram for a surface identification sensor using reflected light and machine learning.

### DETAILED DESCRIPTION

Materials of many types are in wide use globally. The materials can include natural materials, materials formed from natural materials, manufactured materials, and so on. The natural materials can include cotton, wool, bamboo, silk, and wood, among many additional materials. Metal is another commonly used material. Metals can be used in their elemental or alloyed forms such as aluminum, titanium, and steel. Steel alloys are useful because they can be based on combinations of iron and other elements such as carbon, nickel, chromium, molybdenum, cobalt, and others, which are added in various proportions to achieve hardness, toughness, and corrosion resistance. Other steel alloys are formed for their ductility and malleability. Further materials include glass and ceramic, which have myriad applications that include housing, transportation, safety, and tableware. Manufactured materials can include plastics which are based on organic polymers. These latter materials include synthetic and “bio-based”versions. The synthetic plastics are generally derived from carbon-based substances such as coal, natural gas, and oil that are nonrenewable. The bio-based plastics are derived from renewable sources such as vegetable fats and oils, starch, and carbohydrates. Other bio-based plastics are derived from additional, previously unused renewable sources such as biomass waste or animal waste products. Many of these materials can be reused and recycled, which is particularly fortuitous and desirable since the petroleum-based plastics have a very long lifespan. Other materials, such as bio-based plastics, biodegrade over time, thereby reducing plastic amounts in landfills or at large in the environment.

Depending on the type of material, various techniques can be used to test the material. Some of the testing techniques are destructive while others are not. Also, some tests require specialized equipment to perform the tests. When the material is a metal, common testing techniques often include appearance, spark, Rockwell hardness, and Brinell hardness tests. The appearance test can be conducted by a visual inspection of the metal. The visual inspection can also use a hand magnifier or loupe. The appearance test classifies metal and does not require equipment, but is not necessarily accurate or conclusive. The spark test is again based on appearance of a spark or a lack of a spark. The spark test classifies metal, requires equipment, and requires a trained individual. The Rockwell hardness test requires no special equipment, and tests metal hardness by a depth of an impression. The metal surface must be prepared prior to the test. The Brinell hardness test is used on rough surfaces and requires special equipment to test the metal hardness and measures the area of the impression. Similar and other tests can be applied to materials such as fabrics, plastics, and other materials. For example, density measurements can be made on carpeted surfaces using pile fiber density and tufts per inch. These measurements can be useful to predict carpet lifespan.

Sensing surfaces is enabled by a surface identification sensor utilizing reflected light and machine learning. A housing is used, wherein the housing includes a first light source and a first photosensor for the first light source, wherein the first light source is mounted to project light downward and the first photosensor is mounted to capture light reflected upward from a surface, and wherein data from the first photosensor is used with a machine learning model. The housing is moved, within a minimum distance, along the surface, wherein the minimum distance allows for detection, by the first photosensor, of reflected light from the first light source off the surface. Light is sent from the first light source. Reflected light from the first light source is captured by the first photosensor. An output of the first photosensor is interpreted, by the machine learning model, wherein the interpreting recognizes a texture of the surface. A composition of the surface is identified based on the texture.

Techniques for sensing surfaces are disclosed. The sensing of surfaces is enabled by a surface identification sensor using reflected light and machine learning. Materials of various types can be determined by visual inspection. Criteria such as color, texture, weight, density, hardness, and so on, can be used to determine a material. At times, a visual inspection of a material can successfully determine the material. The visual inspection can determine color; a surface treatment such as glossy, semi-glossy, or matte; a surface texture such as rough or smooth; and so on. The determination is complicated, however, by the fact that different materials can present similar visible characteristics. For example, various species of woods and types of marble can present graining even though the materials are significantly different. Material identification can be enhanced by illuminating a surface with light such as infrared light. The infrared light can be provided by an infrared light emitting diode. A portion of the light that illuminates the surface can be reflected up, back or across the surface. The reflected light can be captured by a photosensor that is appropriate for the type of light that illuminates the surface. The photosensor can include a semiconductor sensor such as an infrared transistor. An output of the photosensor can be interpreted, where the interpreting recognizes a texture of the illuminated surface. The interpreting can be performed using a trained machine learning model. The model is trained using labeled training data, where the training data includes data associated with textures. The textures are associated with materials such as wood, tile, plastic, and so on. The trained model can include a convolutional neural network, where the convolutional neural network is executed on microcontroller. A composition of the surface is identified based on the identified texture.

Civilization relies on a wide variety of materials for clothing, shelter, transportation, and communication, among many other uses. The materials implemented for the various uses are chosen based on availability, cost, geographic location, and local customs. While lightweight, natural materials can be popular for clothing in hot climates in some countries, such clothing is shunned by local custom or even prohibited in other countries. Similarly, building materials that are plentiful in some geographic locations are simply unavailable in others. The materials that are widely used include natural materials, materials formed by combining natural materials, manufactured materials, synthetic materials, and so on. For example, carpets can be made from nylon, olefin, polyester, wool, and the like. Popular natural materials include cultivated and wild materials such as cotton, wool, bamboo, silk, and wood, among others. Metal, which is another commonly used material, can be used in elemental or alloyed forms depending on availability, cost, and weight. Commonly used metals include aluminum, titanium, steel, iron, zinc, and bronze. Alloys such as steel alloys are particularly useful because they can be based on combinations of iron and other elements including carbon, nickel, chromium, molybdenum, cobalt, and others. These latter elements are added in various proportions to achieve hardness, toughness, and corrosion resistance. Other steel alloys are formed for their ductility and malleability.

Glass and ceramic of various types are commonly used for myriad applications. The glass and ceramic applications include housing, transportation, safety, tableware, and other household items such as bathroom fixtures. Other materials, such as plastics, are manufactured. The plastics are based on organic polymers and can be synthetic or “bio-based”. The synthetic plastics are derived from carbon-based substances that are nonrenewable. The bio-based plastics are derived from renewable sources such as vegetable fats and oils, starch, and carbohydrates. The bio-based plastics are also derived from previously unused renewable sources such as biomass waste or animal waste products. Many materials can be reclaimed, reused, and recycled. Other materials biodegrade over time.

Identification of a material is critical to using the material properly and safely. Identification of the material can be accomplished using a variety of techniques such as testing the material. The testing techniques can include nondestructive techniques and destructive techniques. The testing techniques can include weighing the material, determining specific gravity, visually inspecting the material under various wavelengths of light, and so on. Some of the tests can be conducted using little or no equipment, while other tests require specialized equipment and training. If the material is a metal, then common testing techniques include appearance, spark, Rockwell hardness, and Brinell hardness tests. The appearance test is based on conducting a visual inspection of the metal to determine color, reflectivity, and structure, among other characteristics. The visual inspection can be performed using the “naked eye”, a hand magnifier, or a loupe. The appearance test classifies the metal without requiring specialized equipment, but is not necessarily accurate or conclusive. The spark test is based on striking the metal to generate a spark (or not). The spark test also classifies metal using equipment and requires a trained individual. The Rockwell hardness tests metal hardness from depth of an impression in the metal. The metal surface must be prepared prior to the test, but otherwise does not require specialized equipment. The Brinell hardness test requires specialized equipment to test the metal hardness, measures the area of the impression, and is used on a rough surface. Various tests such as these tests and other tests can be applied to materials such as fabrics, plastics, and other materials. For example, density measurements can be made on carpeted surfaces using pile fiber density and tufts per inch. These measurements can be useful to predict carpet lifespan.

The use of light sources and photosensors greatly enhances visual inspection of materials. Illuminating a material and detecting light that reflects from the material enables identification of surface characteristics such as texture and composition of the materials. Material surface sensing is based on using a light source to illuminate the surface. Light that reflects upward, back, or across the surface can be captured using a photosensor, thereby forming one or more analog data channels. The sensing is enabled by moving a housing that includes the light source and the photosensor across the surface. The reflected light captured by the photosensor generates a signal from the one or more analog channels. The generated signal can be analyzed to determine the surface characteristics such as surface texture and surface composition. A microcontroller that is coupled to the light source and the photosensor performs the analysis of the analog signal. Further, the microcontroller controls the light source and collects data from the photosensor. The collected data is analyzed using a trained machine learning model that is executed on the microcontroller. The machine learning model can be used to configure a convolutional neural network on the microcontroller. The machine learning model uses the photosensor data to interpret a texture of the surface. A composition of the surface is identified based on the texture.

Sensing techniques that enable determination of various characteristics associated with materials are disclosed. Among other characteristics, the sensing of materials enables surface identification of the materials. The surface identification includes identifying a texture associated with the surface. The texture can include a variety of qualities such as highly reflective or “shiny”, semi-reflective, or matte. The texture can further include smooth, rough, shallow, and deep. The texture also can include lines, grains, and structures. Light from a light source is used to illuminate the material surface. The light can include various wavelengths of bands of light such as infrared light. As the light source is moved across the surface, some of the light reflects from the surface and is captured by a photosensor. The photosensor is sensitive to the light provided by the light source. An output signal from the photosensor is provided to a trained machine learning model which interprets the output signal. The machine learning model is trained using labeled data, where the labeled data can be based on historical data, synthesized data, etc. The trained machine learning model interprets the photo sensor output to recognize a texture of the surface. Using the recognized texture of the surface, a composition of the surface is identified. The identified composition of the surface includes wood, tile, carpet, and so on.

The sensing of surfaces is enabled by a surface identification sensor using reflected light and machine learning. Materials of various types can be determined by visual inspection. Criteria such as color, texture, weight, density, hardness, and so on, can be used to determine a material. At times, a visual inspection of a material can successfully determine the material. The visual inspection can determine color; a surface treatment such as glossy, semi-glossy, or matte; a surface texture such as rough or smooth; and so on. The determination is complicated, however, by the fact that different materials can present similar visible characteristics. For example, various species of wood and types of marble can present graining even though the materials are significantly different. Material identification can be enhanced by illuminating a surface with light such as infrared light. The infrared light can be provided by an infrared light emitting diode. A portion of the light that illuminates the surface can be reflected up, back, or across the surface. The reflected light can be captured by a photosensor that is appropriate for the type of light that illuminates the surface. The photosensor can include a semiconductor sensor such as an infrared transistor. An output of the photosensor can be interpreted, where the interpreting recognizes a texture of the illuminated surface. The interpreting can be performed using a trained machine learning model. The model is trained using labeled training data, where the training data includes data associated with textures. The textures are associated with materials such as wood, tile, plastic, and so on. The trained model can include a convolutional neural network, where the convolutional neural network is executed on a microcontroller. A composition of the surface is identified based on the identified texture.

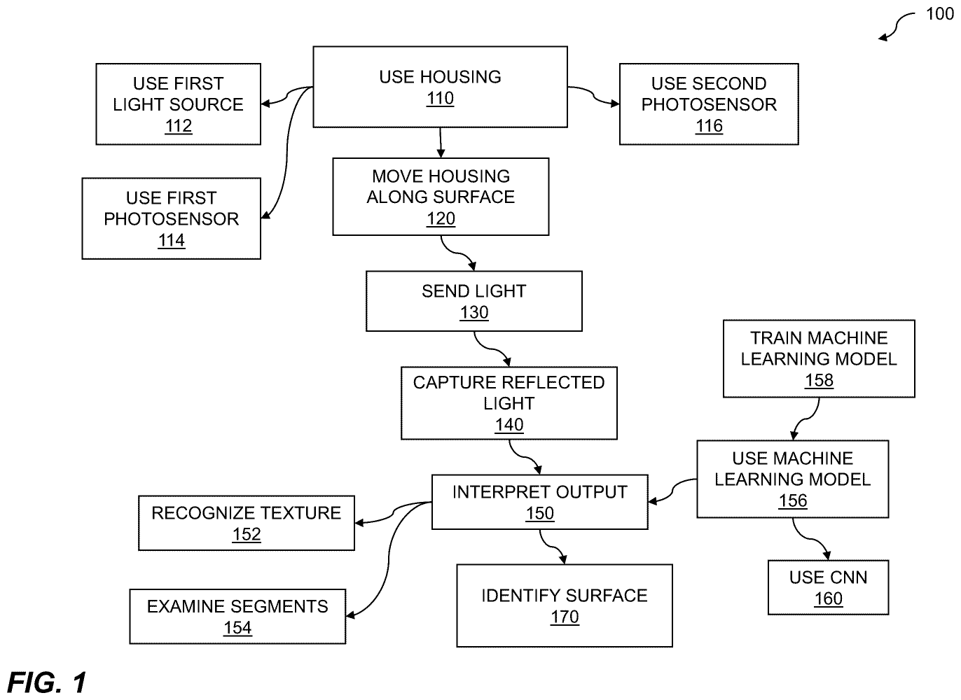

FIG. 1 is a flow diagram for a surface identification sensor utilizing reflected light and machine learning. Light can be used to obtain information about a surface. The information associated with the surface can include texture, composition, and so on. By illuminating the surface with light from a light source, light that reflects from the surface can be captured by a photosensor. The light source and the photosensor can be mounted to a housing that can be moved over the surface. The captured light provides information about the surface. The information such as a surface texture can be interpreted using a machine learning technique. A material composition can be identified from the texture. Since the surface can be rough, deep, and so on, a second photosensor can also be used. The second photosensor can be used to supplement provided information about the surface. The sensors can be used individually when one of the sensors is blocked from receiving light by the material. The sensing of the surface is enabled by a surface identification sensor utilizing reflected light and machine learning. A housing is used, wherein the housing includes a first light source and a first photosensor for the first light source, wherein the first light source is mounted to project light downward and the first photosensor is mounted to capture light reflected upward from a surface, and wherein data from the first photosensor is used with a machine learning model. The housing is moved, within a minimum distance, along the surface, wherein the minimum distance allows for detection, by the first photosensor, of reflected light from the first light source off the surface. Light is sent from the first light source. Reflected light from the first light source is captured by the first photosensor. An output of the first photosensor is interpreted, by the machine learning model, wherein the interpreting recognizes a texture of the surface. A composition of the surface is identified based on the texture.

The flow 100 includes using a housing 110. The housing can include an enclosure, a structure, a framework, and so on. The housing can include a variety of sizes and shapes. In embodiments, the housing can include a portable, handheld housing. The housing can include a shape such as a box, a puck, an oval, and the like. The housing can include a variety of materials such as metal, plastic, fiber reinforced nylon (FRN), carbon fiber, and the like. The shape and the material of the box can be chosen based on criteria such as size, weight, cost, etc. In the flow 100, the housing includes a first light source 112. The first light source can include an inexpensive, low energy consumption light source such as an LED light source. The light source can provide light in a band such as a color of visible light. The light source can provide light in a band such as an infrared (IR) band. In embodiments, the first light source can include a first infrared (IR) light emitting diode (LED). The IR LED can have a broad beamwidth, a narrow beamwidth, etc. In embodiments, the first light source is mounted to project light downward. The first light source can be mounted to the housing at a substantially 90° angle with respect to the surface that can be illuminated by the first light source. It should be noted that “substantially” in this context can mean within manufacturing tolerances and/or within 5° of the stated angle. It should be further noted that while a substantially 90° angle is sometimes preferable, other angles can provide meaningful data according to disclosed techniques. In embodiments, a substantially 45° angle is employed.

In the flow 100, the housing includes a first photosensor 114 for the first light source. The first photosensor can include a sensor associated with the same light band as the light source. The photosensor can include a Red-Green-Blue (RGB) sensor when the light source includes visible light, an IR sensor when the light source includes an IR source, and so on. The photosensor can include a low, medium, or high gain sensor, such as a photodiode, a phototransistor, and a photo Darlington pair, respectively. In embodiments, the first photosensor can be a first IR transistor. The first photosensor can be mounted to the housing at various positions. In embodiments, the first photosensor is mounted to capture light reflected upward from a surface, thus providing one or more analog data channels. The first photosensor can be mounted adjacent to the first light source, at a distance from the first light source, etc. In further embodiments, data from the first photosensor is used with a machine learning model. The machine learning model can be trained to interpret surface textures, surface compositions, and so on. The machine learning model can be trained with a training dataset. The training dataset can include data that has been labeled with respect to textures, compositions, etc. The training dataset is applied to the machine learning model. Weights and biases associated with the machine learning model can be adjusted so that the model correctly identifies a texture, a composition, and so on. The adjusting weights improves accuracy and convergence of the model.

Many types of machine learning (ML) models exist that can be used for interpreting surface textures, identifying surface compositions, and so on. The choice of ML model can be based on a variety of criteria such as accuracy requirements; processor resource capabilities such as processor speed and memory, size, power consumption; and so on. The ML models can be based on techniques such as regression, classification, and so on. ML regression models can be applied to data where the response of the model can be continuous. A regression ML model can be used to predict an outcome based on the data, such as predicting a texture or a composition. Regression can fit a curve to data such as the training data, then can use the curve to make predictions about new data such as production data. ML regression models can be based on linear regression, nonlinear regression, Gaussian progress regression (GPR), and/or support vector machines (SVMs). ML regression models can be based on shallow or deep neural networks. In embodiments, the machine learning model can include a convolutional neural network (CNN). ML classification models can be applied to data where the model response can include a set of classes. A result can indicate that data is a member of a class or not a member of a class. A class can include a texture, a composition, and so on. In a usage example, training data can include images of flooring. Carpeting can be classified as members of a class “is a carpet”, while wood, tile, etc. can be classified as not members of the class “is a carpet”. ML classification models can include a decision tree, a k-nearest neighbor (KNN), an SVM, a shallow or deep neural network, a naive Bayes classifier, etc. As for an ML regression model, a neural network for an ML classification model can include a convolutional neural network, a multilayer perceptron, a recurrent neural network, a long short term memory network, and a transformer model, to name just a few.

In the flow 100, the housing can include a second photosensor 116 for the first light source. The second photosensor can include a semiconductor sensor, where the semiconductor sensor can include a sensor substantially similar to the first semiconductor sensor. In embodiments, the housing can include a second IR transistor for the first IR LED. The second IR transistor can be mounted to the housing at various positions. In embodiments, the second photosensor for the first light source captures light reflected upward from a surface, thus providing a second analog data channel. The second photosensor can be mounted to a top of the housing, to a side of the housing etc. In embodiments, the first IR LED can be mounted at a first angle to the surface. Discussed previously, the first IR LED can be mounted to a top of the housing, a side of the housing, etc. In embodiments, the first IR LED and the first IR transistor can be mounted on a top of the housing at an angle of substantially 90° from the surface. Light from the IR LED can shine down onto the surface, and reflected light can travel up from the surface.

In embodiments, the second IR transistor can be mounted at a first angle to the surface on a same side of the housing as the first LED. The first angle can include a substantially 90° angle with respect to the surface. The first angle can include an angle between substantially 0° (zero) and substantially 90°. In embodiments, the first angle can be substantially 45° with respect to the surface. The second IR transistor can be mounted to the same side of the housing as the IR LED, to an opposite side, etc. In embodiments, the first IR transistor can be mounted at a second angle on an opposite side of the housing to the first IR LED. The second angle can be substantially similar to the first angle or substantially different from the first angle. In embodiments, the second IR semiconductor sensor for the first IR LED is mounted at the first angle to the surface on a same side of the housing as the first LED. The second IR semiconductor sensor can detect light reflected from the surface at the first angle. The second IR semiconductor sensor can be placed adjacent to or at a distance from the first IR LED. In embodiments, the housing can include a second light source. The second light source can be mounted at the top of the housing, at a side of the housing, and so on. The second light source can be substantially similar to the first light source. In embodiments, the second light source can include an IR LED. The second light source can be used to further illuminate the surface. Light can be captured by the first photosensor or the second photosensor, even when one of either the first light source or the second light source is occluded from emitting light.

The flow 100 includes moving 120, within a minimum distance, the housing along the surface. The minimum distance allows for detection, by the first photosensor, of reflected light from the first light source off the surface. The minimum distance can include a distance in millimeters, centimeters, and so on. The moving the housing can be accomplished manually by an individual. The moving the housing can include semi-autonomous movement, autonomous movement, etc. Further embodiments can include detecting, by the first IR transistor, infrared light originating from the first IR LED after it bounces off the surface. The first IR transistor can generate a signal, where the signal is associated with an amount of IR light that can be detected. Further embodiments can include detecting, by the second IR transistor, infrared light originating from the first IR LED after it bounces off the surface. The reflected light can include light reflected back from the surface, across the surface, and the like. Either or both of the IR transistors can be used for the detecting. The detecting can be enabled, even when one of the first photosensor or the second photosensor is occluded from receiving reflected light from the first light source. The occluding can occur based on a texture of a surface blocking one of the IR transistors. In a usage example, the housing can be moved over a deep pile carpet such as a shag carpet. As the housing is moving, one or more of strands associated with the carpet can occlude one IR transistor or the other IR transistor. Since the housing is moving, the occlusion should only be temporary.

The flow 100 includes sending light 130 from the first light source. The sending light can be accomplished by providing a voltage or current to the first light source such as the first IR LED. The sending light can be accomplished by configuring the light source, providing a pulse train to the source, etc. The flow 100 includes capturing 140, by the first photosensor, reflected light from the first light source. The capturing of reflected light can be accomplished by the first photosensor mounted at a top of the housing, at a side of the housing, and so on. In embodiments, capturing reflected light from the first light source can be accomplished by the second photosensor such as the second IR transistor. The second photosensor can be placed on a same side as the first IR LED, on an opposite side to the first IR LED, etc.

The flow 100 includes interpreting 150 an output of the first photosensor. The output of the first photosensor such as the first IR transistor can include an analog signal. The analog signal can include data associated with an amount of light such as IR light detected by the first IR transistor. The amount of light detected by the first photosensor can vary over time as the housing that includes the first photosensor is moved over the surface. In embodiments, the interpreting is based on data from the second photosensor. The first data from the second photosensor can supplement the data from the first photosensor, replace data from the first photosensor, etc. In embodiments, the interpreting can be based on data from the first photosensor or the second photosensor, even when one of the first photosensor or the second photosensor is occluded from receiving reflected light from the first light source. The occluding can occur while the housing is moving over a surface. In the flow 100, the interpreting recognizes a texture 152 of the surface. The texture can include smooth or rough, shiny or dull, flat or tall, deep or shallow, etc. The texture can be associated with a type of material such as wood, plastic, tile, and so on. In the flow 100, the interpreting can further include examining, from the first photosensor, one or more segments 154 of data collected over a timeframe. The collection of these segments of data can occur at a frequency, such as 25 Hz, 50 Hz, 100 MHz, and so on. In embodiments, these segments of data collected at regular intervals are used to train a machine learning model. The segments can be based on portions of a long distance that the housing was moved over the surface. The segments can be associated with two or more minimum distance passes of the housing over the surface. In the flow 100, the interpreting is accomplished by the machine learning model 156. The machine learning model can include a regression model, a classification model, and so on. The machine learning model technique that is used can be selected based on trial and error, computational resource capabilities, cost, and the like. The machine learning model can be selected based on accuracy, convergence speed, etc. The machine learning model can comprise an edge-computing model running on small and/or inexpensive computers, rather than a large GPU-based computer.

The flow 100 further includes training 158 the machine learning model. The training can be based on supervised learning in which a training dataset comprising data and labels associated with the data is used to adjust weights and biases associated with the machine learning model. The adjusting weights increases model accuracy, increases convergence speed, and the like. The training can also include semi-supervised learning in which the labeled data can be used with unlabeled data. The training can further include unsupervised training, where the model tries to identify clusters in the data, trends, etc. In the flow 100, the machine learning model can be based on a convolutional neural network 160. The convolutional neural network can be trained. Further embodiments include training the convolutional neural network with training data representing a plurality of surfaces. The training data can include data and labels associated with a variety of textures, surfaces, etc. In embodiments, a microcontroller hosts a convolutional neural network. The microcontroller can include an inexpensive microcontroller based on an 8-bit, 16-bit, or other precision architecture. In embodiments, the convolutional neural network can operate on a microcontroller. The trained machine learning model can be loaded into the microcontroller. The model can be stored in memory such as non-volatile memory. The model can be executing the machine learning model when the elements associated with the housing, such as the IR LED, the IR transistor, the microcontroller, etc., are powered up.

The flow 100 includes identifying 170 a composition of the surface, based on the texture. The identifying the composition can include identifying a type of material. The material can include wood, plastic, ceramic, glass, metal, etc. The type of material can be based on a context. In a usage example, the housing can be moved within a minimum distance over a horizontal surface. The horizontal surface can include a floor, a counter, a top of a piece of furniture, and the like. The surface can include a hardwood, tiled, or carpeted floor. The surface can include a species of hardwood, a type of ceramic, a pile thickness of a carpet, etc.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

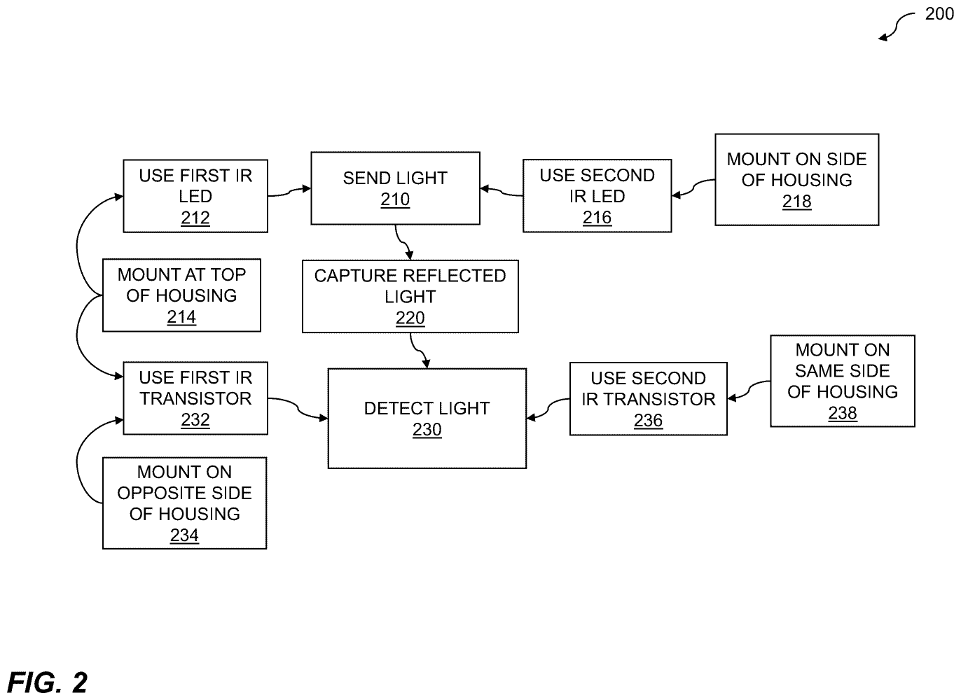

FIG. 2 is a flow diagram for detecting light. Discussed above and throughout, a light source can be used to emit light onto a surface. The light source can include sources associated with a variety of light bands such as visible light, IR light, and so on. The light source can include an inexpensive light source such as an IR LED light source. A portion of the light emitted from the light source reaches a surface and reflects off of the surface. The surface can include a flat or round surface, where the surface can be oriented horizontally, vertically, or at an angle with respect to a horizontal or vertical plane. Reflected light from the surface can be captured by a photosensor. The photosensor can include a semiconductor sensor such as a photo diode, a phototransistor, a photo Darlington pair, etc. The photosensor can detect light associated with the light source. In a usage example, an IR transistor can be used to detect light from an IR LED.

The light source and the photosensor can be mounted to a housing which can be moved. In a usage example, the housing can be moved by an individual using a hand associated with the individual. As the housing is moved, the photosensor mounted to the housing can generate a signal. The signal that is generated by the photosensor can vary as the light source and the photosensor mounted to the housing are moved across the surface. A machine language model can be used to analyze the signal from the photosensor and can interpret the signal. The machine learning model can be trained using a training dataset. The training dataset can include labeled data associated with textures, surface materials, and so on. The labeling of the data indicates a correct texture, surface, etc. identification with which the data is associated. The training dataset is used to adjust weights and biases associated with the machine learning model so that the model correctly interprets textures, identifies surfaces, and the like. The machine learning model can be executed on a network such as a convolutional neural network. When executed, the machine learning model can recognize a texture of the surface over which the light source and the photosensor are moved. The texture of the surface can be used to identify a composition of the surface.

The flow 200 includes sending light 210 from the first light source. The first light source can include a visible light source or an invisible light source. The first light source can include an undirected light source, an inexpensive light source, and so on. In the flow 200, the first light source can be a first infrared (IR) light emitting diode (LED) 212. The IR LED can include a lens to direct the IR light, or may not include a lens so that the IR LED can emit IR light in a broad beam. The first light source can be mounted to a housing. The housing can include a hollow housing that can contain the first light source and other components. The housing can include a mesh, a framework, etc. The housing can include a variety of shapes such as a box, a puck, an oval, etc. The first IR LED can be mounted to the housing. In the flow 200, the first IR transistor can be mounted on a top of the housing 214. The first IR LED can be mounted at the center of the top, off-center, and so on. In embodiments, the first IR LED can be mounted at an angle of substantially 90° from the surface. The first IR LED can be mounted at other positions associated with the housing such as a side of the housing. In other embodiments, the first IR LED can be mounted at an angle of substantially 0° (zero) to 90° with respect to the surface. In embodiments, a second light source can be used to send light onto the surface. In the flow 200, a second light source can be a second infrared (IR) light emitting diode (LED) 216. The second IR LED can be mounted to the housing. In the flow 200, the second IR transistor can be mounted on a side of the housing 218. The second IR LED can be mounted at other positions associated with the housing.

The flow 200 includes capturing reflected light 220 from the first light source. The capturing of the reflected light can be accomplished using a photosensor. The photosensor can be able to capture light emitted by the first light source, light reflected by a surface, and so on. The photosensor can include an inexpensive sensor. The photosensor can include a photo diode, a phototransistor, a photo Darlington pair, and the like. In embodiments, photosensor can be mounted to the housing such that the photosensor can capture light reflected up from the surface. The first photosensor can be mounted at the top of the housing. In other embodiments, the first photosensor can be mounted at a first angle to the surface. The first angle to the surface can include an angle between 0° and 90° with respect to the surface. The first photosensor mounted at a first angle to the surface can capture light that reflects across the surface.

The flow 200 includes detecting reflected light 230 from the first light source off the surface. The detecting can be accomplished using a variety of semiconductor photosensors. In the flow 200, the detecting is accomplished by a first IR transistor 232. The first IR transistor detects light from the first IR LED that reflects or bounces off of the surface. The first IR transistor can be mounted to the housing at various locations. In embodiments, the first IR LED is mounted at a first angle to the surface. When the IR transistor is mounted to a top of the housing, the first angle can be substantially 90°. The first IR transistor can be mounted to a side of the housing. When the first IR transistor is mounted to a side of the housing, the first angle can be between 0° and 90°. The side of the housing to which the first IR transistor is mounted can include the same side to which the first IR LED is mounted. In the flow 200, the first IR transistor is mounted at a second angle on an opposite side 234 of the housing to the first IR LED. The second angle can be substantially similar to the first angle or substantially different from the first angle. In the flow 200, the housing can include a second IR transistor 236 for the first IR LED. The second IR transistor can be mounted at various positions associated with the housing. The second IR transistor can detect IR light bounced back from the surface, across the surface, etc. The second IR transistor can detect backscattered light from the surface. In the flow 200, the second IR transistor is mounted at the first angle 238 to the surface on a same side of the housing as the first IR LED. The second IR transistor can be mounted adjacent to the first IR LED or at a distance from the IR LED. Discussed previously and throughout, an output of the first IR transistor can be interpreted. The interpreting can be accomplished using a machine learning model. The interpreting can recognize a texture of the surface. An output of the second IR transistor can also be interpreted. In embodiments, the interpreting can be based on data from the first photosensor or the second photosensor, even when one of the first photosensor or the second photosensor are occluded from receiving reflected light from the first light source. The occlusion can result from some of the surface material blocking one of the IR transistors. In a usage example, strands from a rug such as a shag rug can block or occlude one of the IR transistors.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

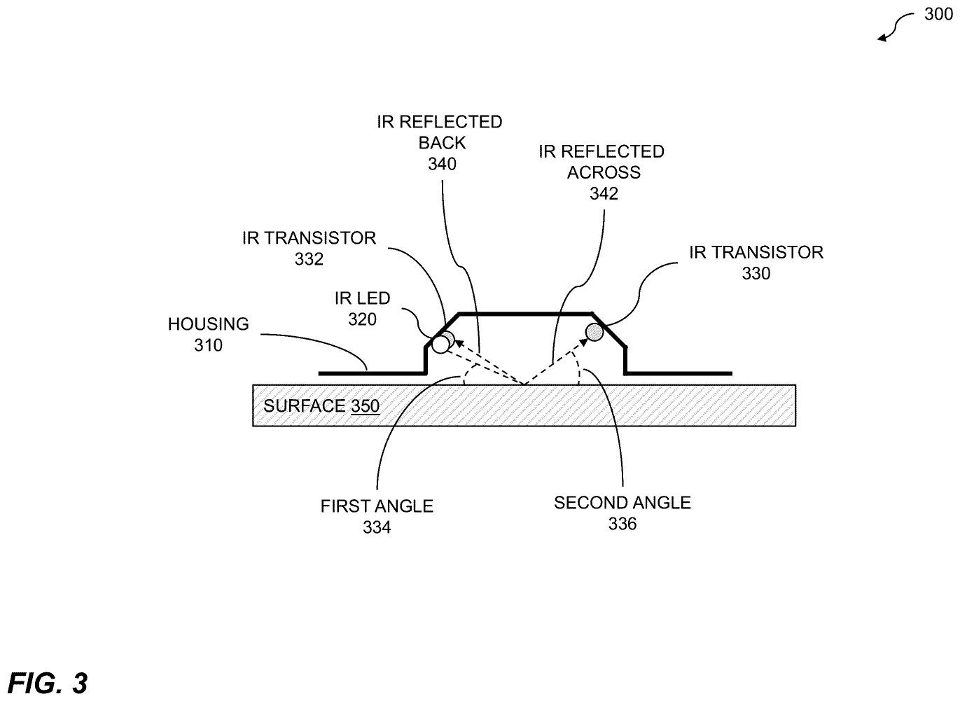

FIG. 3 shows a first example sensor housing configuration. Discussed previously and throughout, a housing can be moved along a surface for surface identification sensing. The housing includes at least a first light source and at least a first photosensor. While moving the housing, a light source can emit light onto a surface, and data associated with light reflected off the surface can be captured by the photosensor. The housing can be moved along a surface by an individual. The data can be interpreted, and a surface composition can be identified. The housing configuration enables a surface identification sensor utilizing reflected light and machine learning. A housing is used, wherein the housing includes a first light source and a first photosensor for the first light source, wherein the first light source is mounted to project light downward and the first photosensor is mounted to capture light reflected upward from a surface, and wherein data from the first photosensor is used with a machine learning model. The housing is moved along the surface, wherein the minimum distance allows for detection, by the first photosensor, of reflected light from the first light source off the surface. Light is sent from the first light source. The first photosensor captures reflected light from the first light source. The machine learning model interprets an output of the first photosensor, wherein the interpreting recognizes a texture of the surface. A composition of the surface is identified based on the texture.

The first sensor housing configuration 300 includes a housing element 310. The housing can include an opaque element, a mesh, a framework, a structure, and so on. The housing can be formed from metal, plastic, and the like. The housing can include a variety of forms such as a box, a three-dimensional polyhedron, a puck, etc. The housing can be sized to be manipulated by an appendage, such as a hand or foot, associated with an individual. In embodiments, the housing can be manipulated remotely, can move autonomously or semi-autonomously, and so on. The housing can include a first light source 320. In embodiments, the first light source can be a first infrared (IR) light emitting diode (LED). The first light source can use other light sources such as a laser diode, an RGB (e.g., visible light) source, etc. In embodiments, more than one light source can be included with the housing. The light source can be mounted on a side of the housing. The housing can include a first photosensor 330. In embodiments, the first photosensor can be a first IR transistor. The first photosensor can include other sensor topologies, configurations, and so on. In embodiments, the first photosensor can include a photo diode, a photo Darlington pair, etc.

In embodiments, the first photosensor can be mounted adjacent to the first IR LED 332. In this case, the first photosensor forms one or more analog data channels. More than one photosensor can be used within the housing. Thus, additional analog data channels can be added. In embodiments, the housing can further include a second photosensor. The second photosensor can include an IR transistor for the first IR LED. The second IR transistor can be positioned within the housing at a location different from the first IR transistor. The IR transistor and the second IR transistor can be mounted at angles with respect to the surface 350. The angle can include a substantially 90° angle, an acute angle less than 90°, and so on. In embodiments, the first IR LED is mounted at a first angle 334 to the surface. The first angle can include a 90° angle (discussed below), an angle between 0° and 90°, etc. In embodiments, the first IR transistor can be mounted at a second angle 336 on an opposite side of the housing to the first IR LED. Because the beam widths of the of the light source and the photosensor are wide, alignment of the light source and the photosensor is not necessarily critical. The first angle and the second angle can be chosen for convenience of mounting the light source and the photosensor. Embodiments can further include detecting, by the first IR transistor, infrared light originating from the first IR LED after it bounces off the surface. The reflecting can include reflecting back toward the first IR LED light source 340. The light that is reflected can be captured by an IR phototransistor positioned on the same side as the IR light source. The light that is reflected can be reflected across 342 the housing. In embodiments, the first IR transistor and the second IR transistor can enable capturing light that is reflected back and light that is reflected across the housing. The use of two or more IR phototransistors can enable supplementing the captured data to enhance identifying and interpreting a surface. In other embodiments, the interpreting can be based on data from first photosensor or the second photosensor, even when one of the first photosensor or the second photosensor is occluded from receiving reflected light from the first light source.

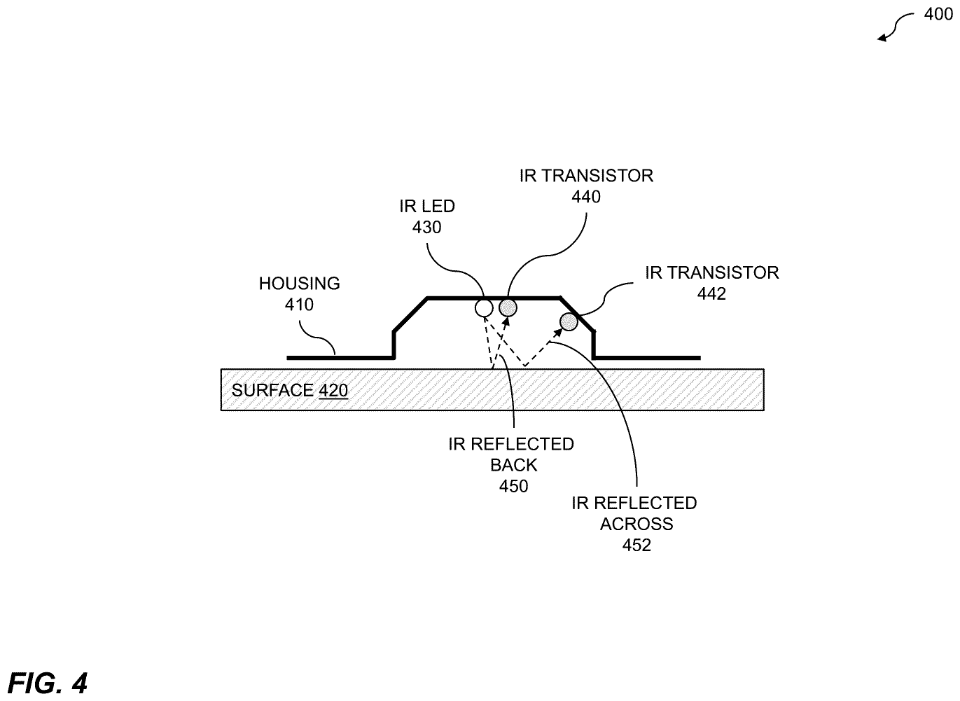

FIG. 4 illustrates a second example sensor housing configuration. A surface of a material can be identified using one or more light sources and one or more photodetectors. The light sources and detectors can be mounted to a housing. Various locations associated with the housing can be used for siting a source or a sensor. The second example sensor housing configuration 400 includes a housing 410. Discussed previously, the housing can include a box, a puck, a framework, a mesh, and the like. The housing can be moved within a minimum distance over a surface 420. The surface can include a flat surface, a round surface, etc. The surface can be oriented horizontally, vertically, at an incline, etc. In embodiments, a first IR LED light source 430 can be mounted on a top of the housing at an angle of substantially 90° from the surface. While mounting the IR LED at the top middle of the housing is shown, the IR LED can be mounted at other locations at the top of the housing. In embodiments, a first IR transistor 440 photosensor can be mounted on a top of the housing at an angle of substantially 90° from the surface. The first IR transistor can be mounted adjacent to the first IR LED. A second IR transistor 442 photosensor can be mounted in the housing at a location different from the location of the IR LED. In embodiments, the second IR transistor can be mounted at a first angle to the surface on a side of the housing. Further embodiments include detecting, by the first IR transistor, infrared light originating from the first IR LED after it bounces off the surface. In the figure, the first IR transistor can detect IR light that reflects back 450 from the surface. Further embodiments include detecting, by the second IR transistor, infrared light originating from first IR LED after it bounces off the surface. In the figure, the second IR transistor can detect IR light that reflects across 452 the surface. The two IR transistors can provide data associated with the IR light reflected back from or across the surface. The data from the IR transistors can be used singly or together to interpret a texture associated with the surface. In embodiments, the interpreting can be based on data from first photosensor or from the second photosensor, even when one of the first photosensor or the second photosensor is occluded from receiving reflected light from the first light source.

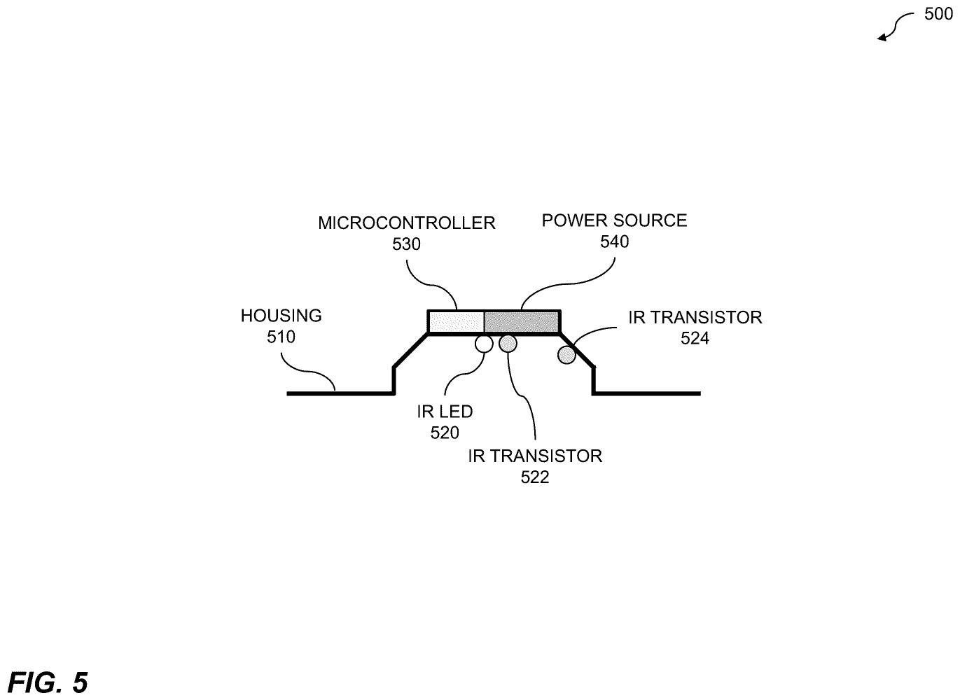

FIG. 5 shows an example surface identification sensor. The surface identification sensor can send light from a light source. The light can include visible light, infrared (IR) light, and so on. A portion of the light that reaches the surface can be reflected by the surface. A photosensor can capture light from the source, reflected light, etc. Data associated with the captured light can be interpreted to recognize a surface texture. The interpreted surface texture can be used to identify surface composition. The surface identification sensor is enabled, utilizing reflected light and machine learning. A housing is used, wherein the housing includes a first light source and a first photosensor for the first light source, wherein the first light source is mounted to project light downward and the first photosensor is mounted to capture light reflected upward from a surface, and wherein data from the first photosensor is used with a machine learning model. The housing is moved within a minimum distance along the surface, wherein the minimum distance allows for detection, by the first photosensor, of reflected light from the first light source off the surface. Light is sent from the first light source. Reflected light from the first light source is captured by the first photosensor. An output of the first photosensor is interpreted by the machine learning model, wherein the interpreting recognizes a texture of the surface. A composition of the surface is identified based on the texture.

The surface identification sensor 500 can include a housing 510. The housing can include a hollow element to which various components can be mounted. The housing can be square, round, ovoid, etc. The housing can include a framework, a mesh, and so on. A light source can be mounted to the housing. The light source can include various wavelengths or bands of light. In embodiments, the light source can include an infrared (IR) light emitting diode (LED) source 520. The light source can be mounted at various locations within the housing. While the IR light source is shown mounted at the top of the housing, the light source can also be mounted to a side of the housing. A photosensor can be mounted to the housing. The photosensor can detect light emitted by the IR LED. The photosensor can include an IR transistor 522, a photodiode, a photo Darlington pair, and the like. While an IR phototransistor is shown mounted at the top of the housing, the IR phototransistor can also be mounted to a side of the housing. In embodiments, a second IR transistor 524 can be mounted to the housing. The second IR transistor can be mounted adjacent to the IR LED, opposite the IR LED, etc. A microcontroller 530 can be mounted to the housing. The microcontroller can include an 8-bit, 16-bit, and so on microcontroller. The controller can control the IR LED and can capture data from the IR transistor. The microcontroller can execute a machine learning (ML) model, where the ML model can be used to interpret an output from a photosensor such as one or more IR transistors. The interpreting the output can recognize a texture of the surface that is being sensed. A power source 540 can be mounted to the housing. The power source such as a battery can power the microcontroller, the IR LED, and one or more IR transistors.

Embodiments include an apparatus for sensing surfaces. The surface can include a flat surface, a round surface, and so on. The surface can be horizontal, vertical, at an incline, etc. A first infrared (IR) light emitting diode (LED) can be located in a housing. The IR LED can be situated at various locations in the housing such as on a top of the housing, on a side of the housing, and the like. The first IR LED is mounted to project infrared light downward toward a surface. The projecting downward toward the surface can include a substantially 90° angle, an acute angle relative to the surface, etc. A first IR semiconductor sensor for the first IR LED can be located in the housing. The first IR semiconductor sensor can be located at a top of the housing, a side of the housing, etc. The first IR semiconductor sensor can be located adjacent to the IR LED, remote from the IR LED, and so on. The first IR semiconductor sensor is mounted to capture light reflected from the first IR LED upward from the surface. The light that is reflected from the surface can include light at a substantially 90° angle to the surface, light at a first angle with respect to the surface, and the like. The apparatus includes a microcontroller. The microcontroller can be based on various precisions such as 8-bit or 16-bit precision, etc. The microcontroller hosts a convolutional neural network. The convolutional neural network can be configured as a machine learning model. The microcontroller is coupled to the first IR LED and the first IR semiconductor sensor. The microcontroller can control the first IR LED and can capture data from the first IR semiconductor sensor. The microcontroller can interpret the output of the first IR semiconductor sensor to recognize a texture of the surface. The apparatus further includes a power source. The power source can include a battery source, a rechargeable battery or capacitor source, a solar source, and so on. The power source is connected to provide power to the first IR LED, the first IR semiconductor sensor, and the microcontroller. The power source is contained within, on, or next to the housing. The power source can be removable for recharging, replacement, upgrading, etc.

In embodiments, the first IR LED, the first IR semiconductor sensor, and the microcontroller that hosts the convolutional neural network are used to identify a composition of the surface, based on interpreting output of the first IR semiconductor sensor using the microcontroller. The first IR LED can send light. The light can be sent out from the IR LED into the housing. The light can illuminate the surface. The first IR semiconductor can capture reflected light from the first IR LED light source. The reflected light can be captured based on the location of the first IR semiconductor sensor. The reflected light can reflect back from the surface toward the IR sensor when the IR sensor is mounted at the top of the housing. The reflected light can include light reflected at a first angle with respect to the surface. In embodiments, a first IR semiconductor sensor and a second IR semiconductor sensor can be mounted to the housing. The semiconductor sensors can detect light that is reflected back and light that is reflected across the surface.

In embodiments, the first IR LED is mounted at a first angle to the surface. The mounting angle of the first IR LED can include substantially 90° to the surface, an angle such as an acute angle with respect to the surface, and so on. In a usage example, the first IR LED can be mounted at an angle substantially equal to 45° with respect to the surface. In embodiments, a second IR semiconductor sensor for the first IR LED can be mounted at the first angle to the surface on a same side of the housing as the first LED. The second IR semiconductor sensor can be mounted adjacent to the first IR LED, at a distance from the first IR LED, and the like. The first IR LED and the first IR semiconductor sensor can be mounted at other positions associated with the housing. In embodiments, the first IR LED and the first IR semiconductor sensor are mounted on a top of the housing at an angle of substantially 90° from the surface. The first IR LED and the first IR semiconductor sensor can be mounted adjacent to each other. While the first IR LED and the first IR semiconductor sensor are shown in the figure to be mounted at the center top of the housing, the IR LED and the IR sensor can be mounted at other locations at the top of the housing. Further embodiments include an external memory, wherein the external memory is coupled to the microcontroller and wherein the external memory is powered by the power source. The external memory can include static RAM (SRAM), dynamic RAM (DRAM), and so on. The external memory can include nonvolatile memory such as magnetic RAM (MRAM), ferroelectric RAM (FeRAM), resistive RAM (ReRAM), and the like. The external memory can include a memory chip, a memory card such as an SD or microSD card, a USB memory, etc. In embodiments, the external memory can be removeable.

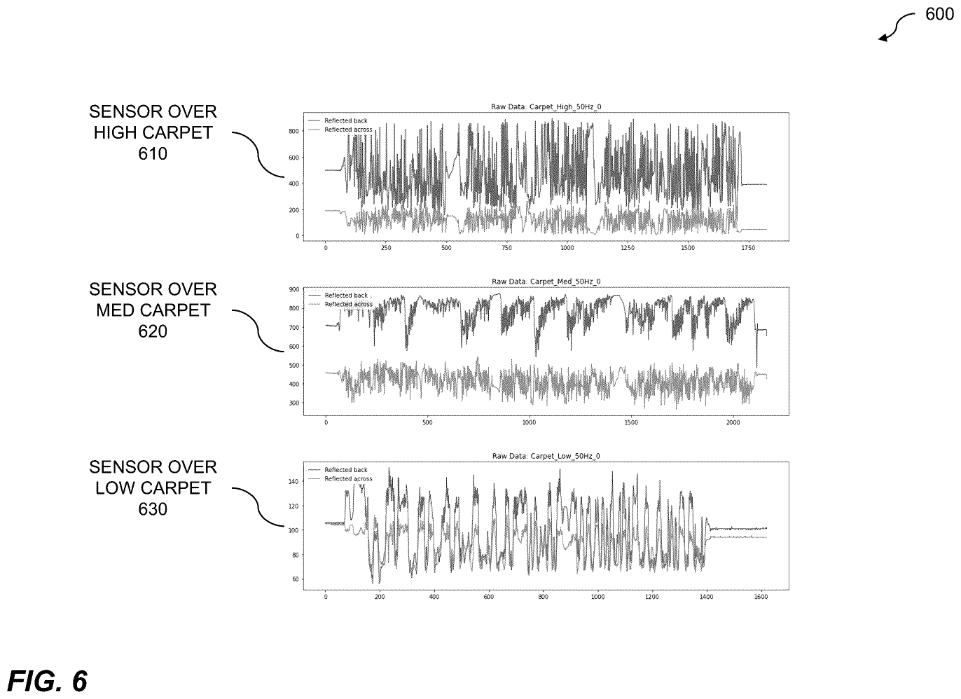

FIG. 6 illustrates carpet sensing data from a surface identification sensor. Discussed previously and throughout, at least a first light source and a first photosensor included in a housing can be used for surface identification. The first light source can send light onto a surface, where the illuminated surface can reflect an amount of light. The surface can include a variety of materials, finishes, treatment, and so on. The surface can include carpet. A second photosensor for the first light source can also be included in the housing. The second photosensor can be used to supplement data received from the first photosensor, to replace data or a lack of data from the first photosensor, and so on. A lack of data from the first photosensor or from the second photosensor can occur when either the first photosensor or the second photosensor is occluded from receiving reflected light from the first light source. The data captured from an output of the first photosensor and/or the second photosensor can be interpreted to recognize a surface texture. The surface can be identified based on the texture. The first light source, the first photosensor, and the second photosensor enable the surface identification sensor utilizing reflected light and machine learning. A housing is used, wherein the housing includes a first light source and a first photosensor for the first light source, wherein the first light source is mounted to project light downward and the first photosensor is mounted to capture light reflected upward from a surface, and wherein data from the first photosensor is used with a machine learning model. The housing is moved within a minimum distance along the surface, wherein the minimum distance allows for detection, by the first photosensor, of reflected light from the first light source off the surface. Light is sent from the first light source. The first photosensor captures reflected light from the first light source. The machine learning model interprets an output of the first photosensor, wherein the interpreting recognizes a texture of the surface. A composition of the surface is identified based on the texture.

The illustration 600 shows plots of reflected light for different carpeted surfaces. The carpeted surfaces can differ based on carpet thickness, bulk, pile, warp and weft, etc. The reflected light that can be captured can include light that is sent down from a light source and reflected back from the surface to a photosensor at the top of the housing. The reflected and captured light can include light from a light source on a side of the housing that is reflected across the material and is captured by a photosensor on another side of the housing. The light that is sent from the light source can include light produced by applying a direct current (DC) voltage or current to the device, an alternating current (AC) pulse or sinusoid, and the like. In embodiments, the first light source can be excited by a 50 Hz voltage or current. The plots include data 610 associated with moving the housing within a minimum distance over a high carpet. The high carpet can include a thick pile carpet, a shag carpet, and the like. The upper graph line of data 610 can include data associated with light such as IR light reflect back from the surface to a photosensor at the top of the housing. The lower graph line of data 610 can include data associated with light reflected across the surface to a photosensor on a side of the housing. The plots can also include data 620 associated with moving the housing within a minimum distance over a medium carpet. The medium carpet can include a medium thickness pile carpet. The upper graph line of data 620 can be based on data associated with light reflected back to a top-mounted photosensor, and the lower graph line of data 620 can be based on data associated with light reflected across the medium thickness carpet. The plots can further include data 630 associated with moving the housing within a minimum distance over a low carpet. The low carpet can include a low thickness pile carpet such as a commercial carpet, an area rug, etc. The upper graph line of data 630 can be based on data associated with light from a top-mounted light source reflected back to a top-mounted photosensor. The lower graph line of data 630 can be based on data associated with light reflected across the low thickness carpet to a photosensor on a side of the housing. The amplitudes, frequency components, separations, etc. of the graph line pairs in data 610, 620, and 630 enable machine learning training data to be extracted for surface identification. The amplitudes, frequency components, separations, etc. of the graph line pairs in data 610, 620, and 630 enable a trained machine learning model to perform surface identification.

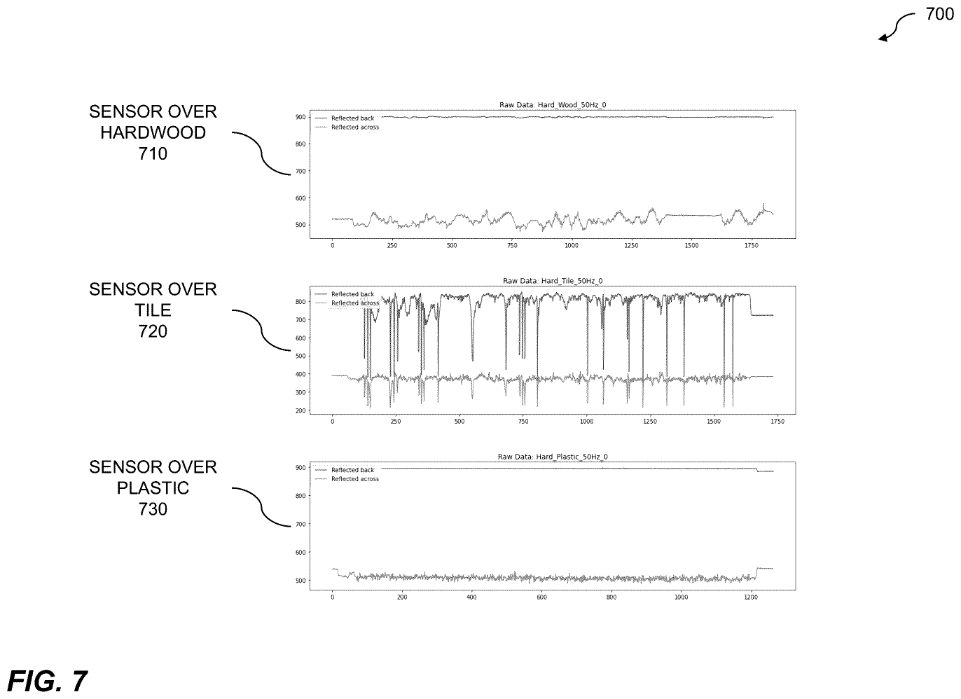

FIG. 7 shows flooring sensing data from a surface identification sensor. The housing that includes a first light source and a first photosensor for the first light source can be moved within a minimum distance along a hard (e.g., non-carpeted) surface. The surface can include a flooring material such as wood, tile, stone, plastic, rubber, and so on. The wood flooring can include hardwood or softwood flooring, wood-laminate flooring, and the like. The tile flooring can include ceramic, stone, etc. The plastic flooring can include polyethene, polypropylene, and so on. One or more plots can be generated based on data captured from one or more photosensors. The photosensors can include photodiodes, phototransistors, photo Darlington pairs, and the like. The plots 700 include data 710 associated with moving the housing within a minimum distance over a hardwood surface. The hardwood surface can include flooring, where the wood associated with the flooring can include oak, maple, cherry, bamboo, walnut, ash, mahogany, and the like. The upper graph of data 710 can include data associated with light such as IR light reflecting back from the surface to a photosensor at the top of the housing. The lower graph line of data 710 can include data associated with light reflected across the hardwood surface to a photosensor on a side of the housing. The plots can also include data 720 associated with moving the housing within a minimum distance over tile. The tile can include porcelain, ceramic, glass, granite, marble, etc. The upper graph line of data 720 can be based on data associated with light reflected back from the tile to a top-mounted photosensor, and the lower graph line of data 720 can be based on data associated with light reflected across the tile from a light source on a side of the housing to a photosensor on another side of the housing. The plots can further include data 730 associated with moving the housing within a minimum distance over plastic. The plastic composition of the tile as discussed above can have a shiny, semi-shiny, or matte surface, etc. The upper graph line of data 730 can be based on data associated with light from a top-mounted light source reflected back to a top-mounted photosensor. The lower graph line of data 730 can be based on data associated with light reflected across the surface of the plastic to a photosensor on a side of the housing. The amplitudes, frequency components, separations, etc. of the graph line pairs in data 710, 720, and 730 enable machine learning training data to be extracted for surface identification. The amplitudes, frequency components, separations, etc. of the graph line pairs in data 710, 720, and 730 enable a machine learning model to perform surface identification.

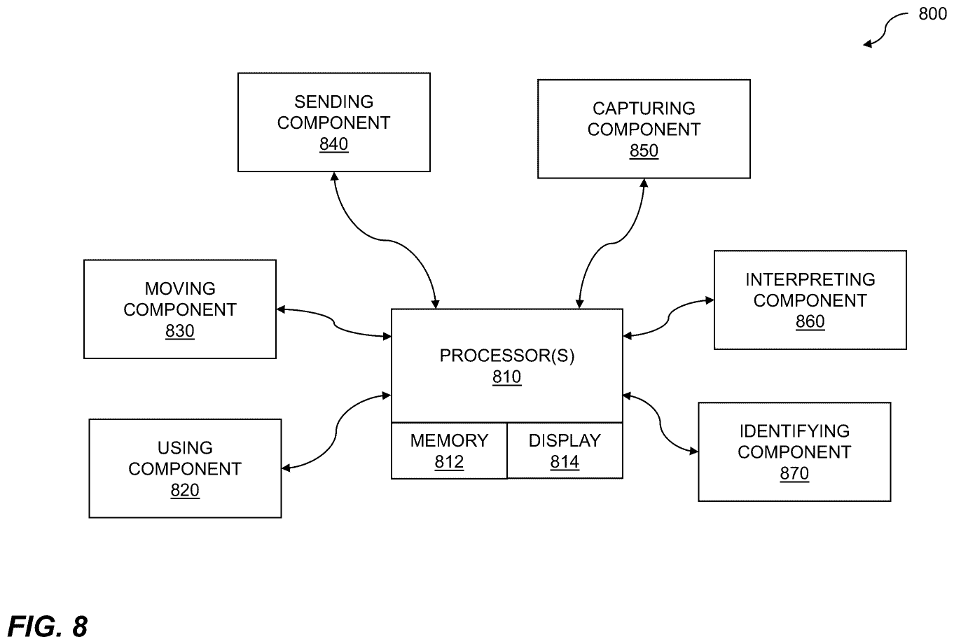

FIG. 8 is a system diagram for sensing surfaces. The sensing of surfaces is enabled by a surface identification sensor utilizing reflected light and machine learning. The system 800 can include one or more processors 810, which are coupled to a memory 812 which stores instructions. The system 800 can further include a display 814 coupled to the one or more processors 810 for displaying data, intermediate steps, machine learning models, reflected light data, surface data, and so on. In embodiments, one or more processors 810 are coupled to the memory 812, wherein the one or more processors, when executing the instructions which are stored, are configured to: use a housing, wherein the housing includes a first light source and a first photosensor for the first light source, wherein the first light source is mounted to project light downward and the first photosensor is mounted to capture light reflected upward from a surface, and wherein data from the first photosensor is used with a machine learning model; move, within a minimum distance, the housing along the surface, wherein the minimum distance allows for detection, by the first photosensor, of reflected light from the first light source off the surface; send light from the first light source; capture, by the first photosensor, reflected light from the first light source; interpret, by the machine learning model, an output of the first photosensor, wherein the interpreting recognizes a texture of the surface; and identify a composition of the surface, based on the texture.

The system 800 can include a using component 820. The using component 820 can include logic and functions for using a housing. The housing can include a solid structure, a mesh, a framework, and so on. The housing can comprise a variety of shapes such as a box, a cup, a puck, and the like. The housing can further include a variety of sizes. In embodiments, the housing can include a size that can be manipulated manually. The housing can contain a variety of components that can be utilized for surface sensing. In embodiments, the housing includes a first light source and a first photosensor for the first light source. The first light source can include one or more light wavelengths or bands such as visible light, infrared (IR) light, etc. In embodiments, the first light source can be a first infrared (IR) light emitting diode (LED). The photosensor can include a semiconductor photosensor. In embodiments, the first photosensor can include a first IR transistor. The first photosensor can further include a photodiode, a photo Darlington pair, and the like. The housing can further comprise one or more of a microcontroller, a battery, a switch, a display, etc. The first light source and the first photosensor can be mounted to the housing in various configurations, orientations, and so on. In embodiments, the first light source is mounted to project light downward and the first photosensor is mounted to capture light reflected upward from a surface. The first light source and the first photosensor can be mounted to a top of the housing, to sides of the housing, etc. The mounting angles of the first light source and the first photosensor can include an acute angle with respect to the surface to be identified, a 90° angle, and so on. Reflected light data associated with the first photosensor can be captured, analyzed, used, etc. In embodiments, data from the first photosensor is used with a machine learning model. The machine learning model can be used to identify a surface. The surface can include wood, stone, tile, carpet, and the like. In embodiments, the machine learning (ML) model can include a convolutional neural network (CNN). The CNN can be used to execute an ML model that has been trained to sense surfaces.

In embodiments, the housing includes a second photosensor for the first light source and wherein the second photosensor for the first light source captures light reflected upward from a surface. The second photosensor can be mounted adjacent to the first photosensor on a top or a side of the housing, can be mounted on a side of the housing opposite the first photosensor, and so on. The second photosensor can be substantially similar to the first photosensor, can have a different gain with respect to the first photosensor, and the like. In other embodiments, the housing can include a second IR transistor for the first IR LED. The second IR transistor is mounted at a first angle to the surface on a same side of the housing as the first LED. The second IR transistor can be mounted at a second angle to the surface, on an opposite side of the housing, etc.

The system 800 can include a moving component 830. The moving component 830 can include logic and functions for moving a sensor within a minimum distance. The moving can be accomplished autonomously, semi-autonomously, manually, and so on. In embodiments, the moving can be accomplished by an individual using a hand, a foot, etc. The minimum distance allows for detection, by the first photosensor, of reflected light from the first light source off the surface. The minimum distance can be associated with a usage scenario, a surface type, an accuracy level, and so on. In embodiments, the minimum distance includes linear distance such as a horizontal distance, a vertical distance, an arced distance, a compound distance such as forward and right, etc. In embodiments, the minimum distance can include a number of millimeters. In embodiments, the housing is moved along the surface. The surface can include a flat surface, a round surface, an angled surface, etc. The allowing for detection can be enabled by a sequence of minimum moves; a series of move, lift, return, and repeat actions; etc.

The system 800 can include a sending component 840. The sending component 840 can include logic and functions for sending light from the first light source. The sending can be accomplished by energizing the first light source, opening a shutter, etc. The sending can be enabled by moving the housing. The energizing the light source can include applying a voltage or a current to the first light source, providing pulses to the first light source etc. The light that can be sent depends on the type of light source. Discussed previously, the light source can include a visible light source such as an RGB source. In embodiments, the first light source emits IR light. The system 800 can include a capturing component 850. The capturing component 850 can include logic and functions for capturing, by the first photosensor, reflected light from the first light source. The reflected light that is captured is based on the light emitted by the first light source. In embodiments, the captured light can include IR light. The first photosensor can capture light that can be different from the source light. The captured light can include fluorescence response light, phase-shifted light, etc.

The system 800 can include an interpreting component 860. The interpreting component 860 can include logic and functions for interpreting, by the machine learning model, an output of the first photosensor. The machine learning (ML) model can include a model that has been trained for the interpreting. The ML model can be trained using various techniques such as supervised training, semi-supervised or hybrid training, unsupervised training, etc. In a usage example, supervised training of the ML model can be accomplished by providing a labeled dataset. The labeled dataset can include data associated with a variety of surfaces such as wood, carpet, tile, stone, and so on. The labeling of the dataset can include a label, inference, conclusion, etc., associated with elements of the dataset. In a usage example, reflected light data captured by the first photosensor of a surface can include a label that identifies the surface such as wood flooring. The training of the ML model is accomplished by adjusting weights associated with and applying biases to the ML model. The training progresses while accuracy and rate of convergence of the ML model is improved. In embodiments, the interpreting recognizes a texture of the surface. Discussed previously and throughout, the texture of the surface can include smooth, semi-smooth, rough, and so on. The texture of the surface can be interpreted based on an amount of light that is reflected from the surface.

Recall that the housing can include a second photosensor for the first light source. In embodiments, the second photosensor for the first light source can capture light reflected upward from a surface. Data can be collected from the second photosensor. The data can be collected by sampling the output of the first and/or the second phototransistor. The sampling can be performed continuously, during movement of the housing, and the like. In embodiments, the interpreting can be based on data from the second photosensor. The data from the second photosensor can be used to supplement the data collected from the first photosensor. In embodiments, the interpreting can be based on data from the first photosensor or the second photosensor. That is, each sensor or both sensors together can provide sufficient data for the interpreting. In further embodiments, the interpreting can be accomplished, even when one of ether the first photosensor or the second photosensor are occluded from receiving reflected light from the first light source. In a usage example, the housing can be moved over a surface such as a shag rug. One or more strands associated with the pile of the shag rug can occlude reflected light to a photosensor while the other sensor can capture light.

The system 800 can include an identifying component 870. The identifying component 870 can include logic and functions for identifying a composition of the surface, based on the texture. Discussed previously and throughout, the surface from which data has been collected using one or more photosensors can be identified based on whether the surface is reflective, semi-reflective, or dull (e.g., a matte finish); has a fine, coarse, linear, or striated grain such as stone or wood; is thin or dense such as padding or carpet; etc. The identifying can be accomplished using a microprocessor, a microcontroller, and so on. The identifying can be based on matching textures to materials, finding a best fit, and so on. The identifying can be based on a percentage, a threshold, a range, etc. The microcontroller can host a network such as a neural network, a machine learning network, and so on. In embodiments, the microcontroller that hosts the convolutional neural network can be used to identify a composition of the surface, based on interpreting output of the first IR semiconductor sensor. The convolutional neural network can be configured to execute a trained machine learning model. The machine learning model can be trained to identify various types of surfaces, where the surfaces can be associated with flooring materials such as wood, tile, or carpet; countertops; wall treatments; etc.

The system 800 can include a computer program product embodied in a non-transitory computer readable medium for instruction execution, the computer program product comprising code which causes one or more processors to perform operations of: using a housing, wherein the housing includes a first light source and a first photosensor for the first light source, wherein the first light source is mounted to project light downward and the first photosensor is mounted to capture light reflected upward from a surface, and wherein data from the first photosensor is used with a machine learning model; moving, within a minimum distance, the housing along the surface, wherein the minimum distance allows for detection, by the first photosensor, of reflected light from the first light source off the surface; sending light from the first light source; capturing, by the first photosensor, reflected light from the first light source; interpreting, by the machine learning model, an output of the first photosensor, wherein the interpreting recognizes a texture of the surface; and identifying a composition of the surface, based on the texture.

The system 800 can include an apparatus for sensing surfaces comprising: a first infrared (IR) light emitting diode (LED) located in a housing, wherein the first IR LED is mounted to project infrared light downward toward a surface; a first IR semiconductor sensor for the first IR LED located in the housing, wherein the first IR semiconductor sensor is mounted to capture light reflected from the first IR LED upward from the surface; a microcontroller, wherein the microcontroller hosts a convolutional neural network, and wherein the microcontroller is coupled to the first IR LED and the first IR semiconductor sensor; and a power source, wherein the power source is connected to provide power to the first IR LED, the first IR semiconductor sensor, and the microcontroller, and wherein the power source is contained within, on, or next to the housing.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for sensing surfaces comprising:
using a housing, wherein the housing includes a first light source and a first photosensor for the first light source, wherein the first light source is mounted to project light downward and the first photosensor is mounted to capture light reflected upward from a surface, and wherein data from the first photosensor is used with a machine learning model;
moving, within a minimum distance, the housing along the surface, wherein the minimum distance allows for detection, by the first photosensor, of reflected light from the first light source off the surface;
sending light from the first light source;
capturing, by the first photosensor, reflected light from the first light source;
interpreting, by the machine learning model, an output of the first photosensor, wherein the interpreting recognizes a texture of the surface; and
identifying a composition of the surface, based on the texture.

2. The method of claim 1 wherein the housing includes a second photosensor for the first light source and wherein the second photosensor for the first light source captures light reflected upward from a surface and wherein the interpreting is based on data from the second photosensor.

3. The method of claim 2 wherein the interpreting is based on data from the first photosensor and the second photosensor, even when one of the first photosensor or the second photosensor is occluded from receiving reflected light from the first light source.

4. The method of claim 1 wherein the first light source is a first infrared (IR) light emitting diode (LED).

5. The method of claim 4 wherein the first photosensor is a first IR transistor.

6. The method of claim 5 wherein the first IR LED is mounted at a first angle to the surface.

7. The method of claim 6 wherein the first IR transistor is mounted at a second angle on an opposite side of the housing to the first IR LED.

8. The method of claim 7 further comprising detecting, by the first IR transistor, infrared light originating from the first IR LED after it bounces off the surface.

9. The method of claim 8 wherein the housing includes a second IR transistor for the first IR LED, wherein the second IR transistor is mounted at the first angle to the surface on a same side of the housing as the first LED.

10. The method of claim 9 further comprising detecting, by the second IR transistor, infrared light originating from the first IR LED after it bounces off the surface.

11. The method of claim 5 wherein the first IR LED and the first IR transistor are mounted on a top of the housing at an angle of substantially 45° from the surface.

12. The method of claim 11 further comprising detecting, by the first IR transistor, infrared light originating from the first IR LED after it bounces off the surface.

13. The method of claim 12 wherein the housing includes a second IR transistor for the first IR LED.

14. The method of claim 13 wherein the second IR transistor is mounted at a first angle to the surface on a side of the housing.

15. The method of claim 14 further comprising detecting, by the second IR transistor, infrared light originating from first IR LED after it bounces off the surface.

16. The method of claim 1 wherein the first light source is a light emitting diode (LED).

17. The method of claim 1 wherein the interpreting further comprises examining, from the first photosensor, one or more segments of data collected over a timeframe.

18. A computer system for instruction execution comprising:
a memory which stores instructions;
one or more processors coupled to the memory wherein the one or more processors, when executing the instructions which are stored, are configured to:
use a housing, wherein the housing includes a first light source and a first photosensor for the first light source, wherein the first light source is mounted to project light downward and the first photosensor is mounted to capture light reflected upward from a surface, and wherein data from the first photosensor is used with a machine learning model;
move, within a minimum distance, the housing along the surface, wherein the minimum distance allows for detection, by the first photosensor, of reflected light from the first light source off the surface;
send light from the first light source;
capture, by the first photosensor, reflected light from the first light source;
interpret, by the machine learning model, an output of the first photosensor, wherein the interpreting recognizes a texture of the surface; and
identify a composition of the surface, based on the texture.

19. An apparatus for sensing surfaces comprising:
a first infrared (IR) light emitting diode (LED) located in a housing, wherein the first IR LED is mounted to project infrared light downward toward a surface;
a first IR semiconductor sensor for the first IR LED located in the housing, wherein the first IR semiconductor sensor is mounted to capture light reflected from the first IR LED upward from the surface;
a microcontroller, wherein the microcontroller hosts a convolutional neural network, and wherein the microcontroller is coupled to the first IR LED and the first IR semiconductor sensor; and
a power source, wherein the power source is connected to provide power to the first IR LED, the first IR semiconductor sensor and the microcontroller, and wherein the power source is contained within, on, or next to the housing.

20. The apparatus of claim 19 wherein the first IR LED, the first IR semiconductor sensor, and the microcontroller that hosts the convolutional neural network are used to identify a composition of the surface, based on interpreting output of the first IR semiconductor sensor using the microcontroller.

21. The apparatus of claim 19 wherein the first IR LED is mounted at a first angle to the surface.

22. The apparatus of claim 21 wherein the first IR semiconductor sensor is mounted at a second angle to the surface on an opposite side of the housing to the first IR LED.

23. The apparatus of claim 22 wherein a second IR semiconductor sensor for the first IR LED is mounted at the first angle to the surface on a same side of the housing as the first LED.

24. The apparatus of claim 19 wherein the first IR LED and the first IR semiconductor sensor are mounted on a top of the housing at an angle of substantially 45° from the surface.

25. The apparatus of claim 19 further comprising an external memory, wherein the external memory is coupled to the microcontroller and wherein the external memory is powered by the power source.
